(19) United States
(12) Patent Application Publication
(10) Pub. No.: US 2025/0372665 A1
(43) Pub. Date: Dec. 4, 2025

(54) METHOD OF MAKING A GAS DIFFUSION ELECTRODE, METHOD OF MAKING A MEMBRANE-ELECTRODE ASSEMBLY FOR A FUEL CELL, CATALYTIC COMPOSITION FOR A GAS DIFFUSION ELECTRODE

(71) Applicant: BREMBO S.p.A., Curno (Bergamo) (IT)

(72) Inventors: Federico BERTASI, Curno (Bergamo) (IT); Marco BANDIERA, Curno (Bergamo) (IT); Alessandro MANCINI, Curno (Bergamo) (IT); Andrea BONFANTI, Curno (Bergamo) (IT)

(73) Assignee: BREMBO S.p.A., Curno (Bergamo) (IT)

(21) Appl. No.: 18/870,716

(22) PCT Filed: May 24, 2023
(86) PCT No.: PCT/IB2023/055326

§ 371 Date: Dec. 2, 2024

(30) Foreign Application Priority Data
Jun. 1, 2022 (IT) 102022000011654

(51) Int. Cl. H01M 4/88; H01M 4/86; H01M 4/90; H01M 8/10; H01M 8/1004

(52) U.S. Cl. CPC H01M 4/8807; H01M 4/8605; H01M 4/8828; H01M 4/9083; H01M 8/1004; H01M 2008/1095

(57) ABSTRACT

A method of making a gas diffusion electrode (GDE) for an oxygen reduction reaction involves providing a catalytic composition in particle form having at least iron (Fe) in at least two different degrees of oxidation, optionally the at least two different degrees of oxidation being Fe and Fe₂O₃, and carbon, the catalytic composition in particle form being obtained from a tribo-oxidation action caused by a friction of a brake pad against a brake disc. The method further involves combining the catalytic composition in particle form with a liquid phase to obtain a catalytic mixture, depositing the catalytic mixture on a backing sheet and letting the catalytic mixture dry.

### FIELD OF APPLICATION

The present invention relates to a method for making a gas diffusion electrode for oxygen reduction reaction, a method for making a membrane-electrode assembly for a fuel cell, and a catalytic composition for making the gas diffusion electrode.

### BACKGROUND ART

Fuel cells (hereafter FCs) are a class of electrochemical devices which allow the direct conversion of chemical energy into electrical energy with high efficiency. In particular, FCs are capable of generating electric power from oxygen (O₂) and hydrogen (H₂) according to the reaction: 2H₂+O₂→electric current+2H₂O. Since water (H₂O) is the only waste product of a fuel cell, automotive solutions based on these devices are referred to as zero-emission vehicles. In a fuel cell, the production of electrical energy is determined by the use of appropriate catalysts, which allow hydrogen and oxygen to react in a controlled manner, avoiding combustion. FCs that do not use hydrogen as fuel (e.g., direct methanol cells) as well as FCs operating at high temperatures (e.g., molten carbonate fuel cells (MCFCs) or solid oxide fuel cells (SOFCs)) are also known from the prior art.

The operating principle of a fuel cell is based on two electrochemical half-reactions which occur in the anode and cathode compartments of the cell itself, respectively. The anodic half-reaction is the hydrogen oxidation reaction while the cathodic half-reaction is the oxygen reduction reaction. In general, the kinetics of the oxygen reduction reaction (ORR) is very slow and is the limiting step in the process. For the latter to occur effectively for producing electrical energy, it must be facilitated by appropriate materials, precisely named catalysts, the purpose of which is to reduce the energy barrier required to activate the process.

A typical catalyst for ORR is based, for example, on noble metal nanoparticles supported on mesoporous carbon.

Inconveniently, the use of electrocatalysts based on noble metals, in short supply and not always readily available, is associated with a high cost thereof and a high demand for valuable resources typically obtainable from processes with a high environmental impact. Nevertheless, there are several examples of automotive applications (see hydrogen cars) for which fuel cells exhibit competitive advantages over batteries, for example. With particular reference to automotive applications, polymer electrolyte FCs operating at low temperatures (typically 80° C.) are used. In this type of FCs, the anodic and cathodic half-reactions occur in half-cells separated by a thin polymer membrane (e.g., NAFION™). The polymer membrane ensures a physical barrier between the anode and cathode compartments and ensures adequate ion conduction between anode and cathode during device operation.

In a typical polymer electrolyte fuel cell configuration, the catalyst materials are supported on two gas-diffusion electrodes (GDEs) and pressed against the ion-conducting membrane, resulting in a three-layer system consisting of GDE (anode)-Membrane-GDE (cathode). The assembly of the three layers is referred to as a membrane-electrode assembly (MEA).

With particular reference to polymer electrolyte FCs, there are at least two categories: 1) FCs including a proton exchange membrane (hereafter PEMFC); and 2) fuel cells comprising an anion exchange membrane (AEMFC). In PEMFCs, the polymer electrolyte is a proton conductor (H⁺ ions) while in AEMFCs the electrolyte is an anion conductor (hydroxyl OH⁻ ions). This difference causes the electrolyte to create an acidic operating environment in the former case and a basic one in the latter case.

Electrocatalysts for ORRs operating in acidic environments (PEMFCs) are typically based on platinum group metals (PGMs). In contrast, catalysts for ORR operating under basic conditions (AEMFCs) do not necessarily require PGMs and are typically based on metals, such as gold (Au), silver (Ag), and nickel (Ni).

Inconveniently, in both cases (basic environment and acidic environment), the preparation of catalysts for ORR typically requires lengthy, energy-intensive synthesis procedures which include several high-temperature pyrolysis treatments (up to 1000° C.). Moreover, such procedures also often require the use of expensive reagents or precursors which are difficult to use on a large scale.

In addition, the need to employ particularly energy-intensive synthesis processes and the use of PGMs, on the one hand, disadvantageously requires a high use of resources (and strongly influences the final cost of electrocatalysts) and, on the other hand, strongly limits the effectiveness and production efficiency thereof, thus effectively compromising the massive deployment of fuel cells for automotive applications.

In addition, the use of noble metals also entails a significant environmental impact for their extraction.

Therefore, the need for electrocatalysts and electrodes for the oxygen reduction reaction to be used in fuel cells which are capable of reducing energy expenditure and resource utilization becomes immediately apparent.

An additional need is for electrocatalysts and electrodes for the oxygen reduction reaction to be used in fuel cells which are capable of reducing environmental impact.

### OVERVIEW OF THE INVENTION

The aforesaid needs are met by a method of making a gas diffusion electrode, a method of making a fuel cell membrane-electrode assembly, a catalytic composition, and use of a gas diffusion electrode, according to the appended independent claims.

### DESCRIPTION OF THE DRAWINGS

Further features and advantages of the present invention will be more comprehensible from the following description of preferred embodiments thereof, given by way of non-limiting examples, in which:

FIG. 1 shows an exploded axonometric view of a fuel cell assembly (stack) according to an embodiment according to the present invention and comprising fuel cells made according to an embodiment according to the present invention;

FIG. 2 diagrammatically shows the steps of a method of making a membrane-electrode assembly for a fuel cell, according to an embodiment of the present invention;

FIG. 2a diagrammatically shows the steps of a method of making a membrane-electrode assembly for a fuel cell, according to a further embodiment of the present invention;

FIG. 3 shows an image obtained by scanning electron microscopy (SEM) of a powder mixture of the catalytic composition according to an embodiment according to the present invention;

FIG. 4 shows a graph showing the bimodal size distribution of a powder mixture of the catalytic composition according to an embodiment according to the present invention;

FIG. 5 shows a table containing weight percentage indications of a phase composition of a catalytic composition according to an embodiment according to the present invention;

FIG. 5a shows a table containing weight percentage indications of a phase composition of three different catalytic compositions according to an embodiment according to the present invention;

FIG. 6 shows five graphs showing the values of rotating disc electrode voltammetry measurements for a reference electrode Pt/C, for a first rotating electrode RDE1 comprising an appropriate catalytic layer comprising the catalytic composition having a phase composition according to the table in FIG. 5, for a second rotating electrode RDE2 comprising an appropriate catalytic layer comprising the catalytic composition having a phase composition according to the first column of the table in FIG. 5a, for a third rotating electrode RDE3 comprising an appropriate catalytic layer comprising the catalytic composition having a phase composition according to the second column of the table in FIG. 5a, and for a fourth rotating electrode RDE4 comprising an appropriate catalytic layer comprising the catalytic composition having a phase composition according to the third column of the table in FIG. 5a;

FIG. 7 shows the electrode potential of the reference electrode Pt/C of the first rotating electrode RDE1, the second rotating electrode RDE2, the third rotating electrode RDE3 and the fourth rotating electrode RDE4 in FIG. 6;

FIG. 8 shows a table containing ranges of weight percentage indications of a phase composition of a catalytic composition according to embodiments according to the present invention.

The elements or parts of elements common to the embodiments described below will be indicated by the same reference numerals.

### DETAILED DESCRIPTION

In the present discussion, where numerical percentage ranges are given, the extremes of such ranges are always understood to be included unless otherwise specified.

In general, in the present discussion, when reference is made to phrases such as “free of noble metals” or “free of heavy metals” or the like, it will exactly mean the total absence of such metals but also an absence of such metals minus a small amount which may be present because of residual traces or impurities due to the manufacturing process, but still less than 1% by weight.

Moreover, in the present discussion, where not specifically specified, when reference is made to the percentage contents of mixtures, solutions, or compositions, it means percentages by weight with respect to the total weight of the mixture, solution, or composition.

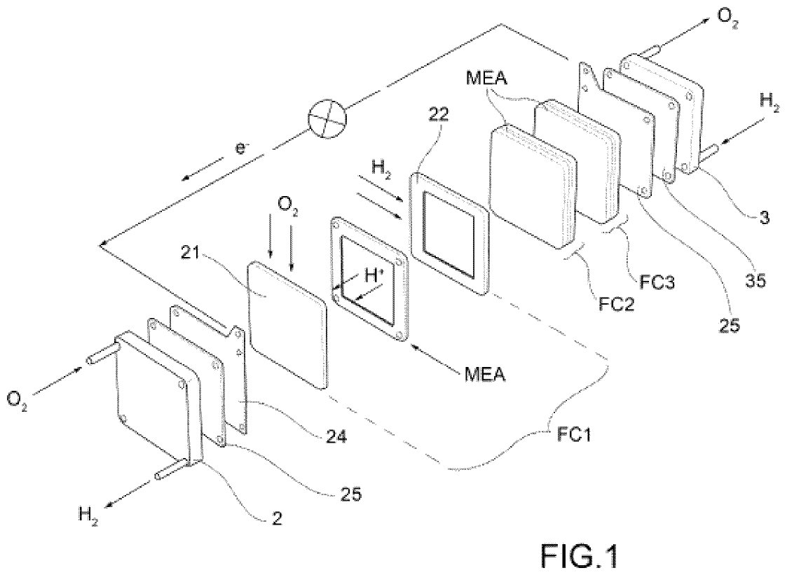

An example of a fuel cell FC1 according to the present invention is shown in FIG. 1.

According to an embodiment, the fuel cell FC1 comprises a head plate 21 and a tail plate 22 on the opposite side, through which oxygen or hydrogen flows in and out of the fuel cell FC1. A membrane-electrode assembly (MEA) is interposed between the head plate 21 and the tail plate 22, which will be described in greater detail later in the present discussion.

In particular, an example of fuel cell assembly 1, in which all fuel cells FC1, FC2, FC3 are made according to the present invention, is also shown in FIG. 1. Such a fuel cell assembly 1 comprises a left end plate 2 and a right end plate 3 which contain the stack of fuel cells FC1, FC2, FC3 therebetween. Moreover, an electrode 24, 34 is interposed at each left 2 and right 3 end plate for the connection with the electrical circuit for collecting the generated current, preferably together with an insulating layer 25, 35 which isolates the electrode 24, 34 from the respective right 3 or left 2 plate.

The membrane-electrode assembly MEA of the fuel cell FC1, FC2, FC3 according to the present invention comprises a gas diffusion electrode (GDE) according to the present invention.

According to the invention, a method of making a gas diffusion electrode (GDE) for oxygen reduction reaction comprises the following operational steps:
a) providing a catalytic composition in particle form comprising at least iron (Fe) in at least two different degrees of oxidation, e.g., Fe and Fe₂O₃, and carbon (C);
b) combining the catalytic composition obtained in step a) with a liquid phase and obtaining a catalytic mixture 10;
c) depositing the catalytic mixture 10 obtained in step b) on a backing sheet 11 and making the catalytic mixture 10 dry.

Advantageously, the catalytic composition provided in step a) is obtained from the tribo-oxidative action caused by the friction of a brake pad against a brake disc.

According to an advantageous constructional variant, the catalytic composition according to the present invention is obtained at least partially from the tribo-oxidative action caused by the friction of a brake pad against a brake disc. However, it is apparent that the present invention also relates to a catalytic composition having per se the compositions indicated in the embodiments described in the present description, regardless of the method with which such compositions are obtained.

Preferably, the brake disc is a cast iron disc, but the possibility of using a coated cast iron or coated steel disc is not excluded.

Preferably, the cast iron disc is a fully pearlitic cast iron disc or is a cast iron disc with non-negligible ferrite content (e.g., with ferrite content greater than 5%).

Preferably, the cast iron disc is a class I, A, 4-5 cast iron disc according to UNI EN ISO 945.

According to an embodiment, in the catalytic composition, iron (Fe) is present only as metallic iron (α-Fe) and magnetite (Fe₃O₄).

According to an embodiment, in the catalytic composition, iron (Fe) is present only as metallic iron (α-Fe) and hematite (Fe₂O₃).

According to an embodiment, in the catalytic composition, iron (Fe) is present only as magnetite (Fe₃O₄) and hematite (Fe₂O₃).

According to an embodiment, the catalytic composition in particle form comprises metallic iron (α-Fe), hematite (Fe₂O₃) and magnetite (Fe₃O₄).

According to an embodiment, in the catalytic composition, iron (Fe) is present only as metallic iron (α-Fe), hematite (Fe₂O₃) and magnetite (Fe₃O₄).

According to an embodiment, the catalytic composition in particle form also comprises metallic zinc (Zn). In this variant, zinc helps to modulate the catalytic properties of the mixture.

According to an embodiment of the method, in step c) the backing sheet 11 is a porous carbon sheet.

According to an embodiment, the liquid phase of step b) consists of a mixture comprising a polar solvent, e.g., a hydroalcoholic solution, comprising an ion-conducting ionomer, e.g., a sulfonated fluoropolymer, and mesoporous carbon.

According to an embodiment, the catalytic composition in particle form consists of at least 15% of ferrous particles, at least 5% of graphite (C), and a content of metallic zinc (Zn) of less than 40%, preferably less than 30%, and other constituents for the remaining percentage by weight.

According to an embodiment, in the present description, when reference is made to “other constituents,” such other constituents of the remaining percentage by weight comprise or consist of copper (Cu), tin (Sn) and possibly oxides thereof.

Preferably, such at least 15% of ferrous particles consists of at least 5% of metallic iron (α-Fe) and at least 5% of magnetite (Fe₃O₄).

Preferably, such at least 15% of ferrous metal particles comprises at least 5% of metallic iron (α-Fe), at least 5% of magnetite (Fe₃O₄) and at least 5% of hematite (Fe₂O₃).

According to an embodiment, the catalytic composition in particle form consists of 5% to 60% of metallic iron, extremes included, 5% to 55% of magnetite, extremes included, 5% to 40% of hematite, extremes included, 5% to 20% of graphite, extremes included, a content of metallic zinc (Zn) of less than 40%, preferably less than 30%, and other constituents for the remaining percentage by weight.

According to an embodiment, the catalytic composition in particle form consists of 5% to 10% of metallic iron, extremes included, 30% to 40% of hematite, extremes included, 40% to 50% of magnetite, extremes included, 5% to 10% of graphite, extremes included, a content of metallic zinc (Zn) of less than 5%, preferably less than 1%, and other constituents for the remaining percentage by weight.

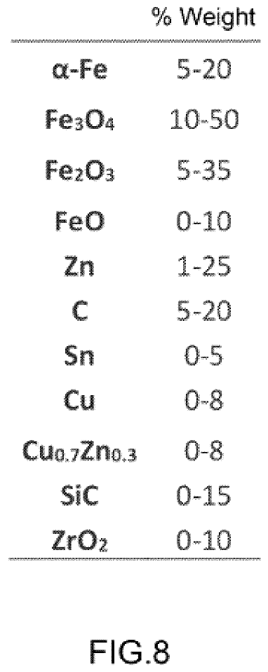

According to an embodiment described in greater detail in FIG. 8, for example, the catalytic composition in particle form consists of 5% to 20% of metallic iron, extremes included, 10% to 50% of magnetite, extremes included, 5% to 35% of hematite, extremes included, 5% to 20% of graphite, extremes included, a content of metallic zinc (Zn) from 1% to 25%, extremes included, and for the remaining percentage by weight of one or more of the following constituents chosen from the group comprising: copper, silicon carbide, zirconium oxide, a copper and zinc alloy.

According to an embodiment, the catalytic composition in particle form consists of 5% to 20% of metallic iron, extremes included, 10% to 50% of magnetite, extremes included, 5% to 35% of hematite, extremes included, 5% to 20% of graphite, extremes included, a content of metallic zinc (Zn) from 1% to 25%, extremes included, and for the remaining percentage by weight of one or more of the following constituents chosen from the group comprising: from 0.1% to 8% of copper, extremes included, from 0.1% to 15% of silicon carbide, extremes included, from 0.1% to 10% of zirconium oxide, from 0.1% to 8% of a copper and zinc alloy, extremes included, and from 0.1% to 5% of tin, extremes included.

Preferably, before step a), the method comprises a step a′), which includes collecting a waste powder from the tribo-oxidation action caused by the friction of a brake pad against a brake disc, preferably a cast iron brake disc, directly near the brake pad and/or brake disc, so as to obtain a catalytic composition in particle form. This allows using a circular economy process, in which unused waste becomes a material for making a new component.

According to an embodiment, before step a), the method comprises a step a″), which includes treating a waste powder from the tribo-oxidative action caused by brake pad against a brake disc the friction of a (preferably made of cast iron) by a filtration process and/or a grinding process and/or a washing process, so as to obtain a catalytic composition in particle form.

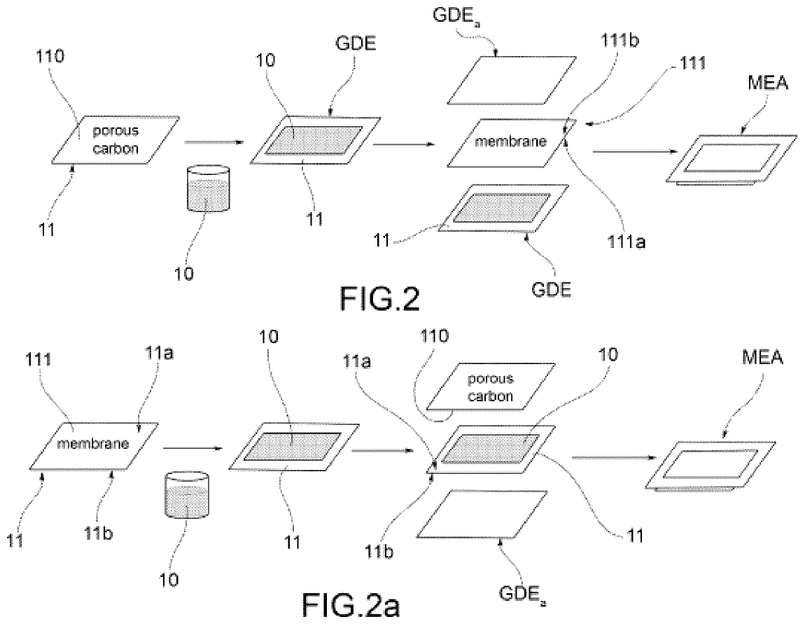

According to an aspect of the invention, a method of making a membrane-electrode assembly MEA for a fuel cell FC1, FC2, FC3 comprises the operational steps of the method of making a gas diffusion electrode GDE in each of the embodiments described in the preceding paragraphs and in general in the present discussion. In addition, the method of making a membrane-electrode assembly MEA comprises the following operational steps, where an example is shown in FIG. 2:
joining a first side 111a of a polymer membrane 111 to the backing sheet 11, for example a porous carbon sheet, of the gas diffusion electrode GDE for the oxygen reduction reaction, so as to obtain a cathode side of the membrane-electrode assembly (MEA);
joining a second side 111b of the polymer membrane 111, opposite to the first side, to a gas diffusion electrode for anodic half-reaction GDEa.

A membrane-electrode assembly MEA is thus obtained, in which the oxygen reduction half-reaction electrode is obtained according to the method of making the gas diffusion electrode GDE according to the present invention. It is apparent that the gas diffusion electrode for the anode half-reaction GDEa is obtained by means of a technique known to those skilled in the art, such as by drop-casting, i.e. by depositing ink droplets on a substrate, or by “doctor-blade,” i.e. by depositing ink on the substrate by means of a blade passing over the substrate at a given distance.

According to an aspect of the invention, a further method of making a membrane-electrode assembly MEA for a fuel cell FC1, FC2, FC3 provides that the backing sheet 11 of the gas diffusion electrode GDE is a polymer membrane 111 instead of being a porous carbon sheet. An example of the method is shown in FIG. 2a. In other words, the method of this embodiment, in addition to comprising the operational steps of the method of making a GDE gas diffusion electrode in each of the embodiments described in the preceding paragraphs and in the present discussion, which are compatible with this embodiment, also comprises the following operational steps:
joining a first side 11a of the backing sheet 11 of the gas diffusion electrode GDE for the oxygen reduction reaction to a porous carbon sheet 110, so as to obtain a cathode side of the membrane-electrode assembly, where the backing sheet 11 of the gas diffusion electrode is a polymer membrane 111,
joining a side 11b opposite to the first side 11a of the backing sheet 11 to a gas diffusion electrode for anodic half-reaction GDEa.

In this variant, the catalytic composition is thus deposited directly onto the polymer membrane 111 and is then coupled to a porous carbon sheet 110.

Again in this variant, a membrane-electrode assembly MEA is obtained, in which the electrode of the oxygen reduction half-reaction is obtained according to the method of making the gas diffusion electrode GDE according to the present invention, while the gas diffusion electrode for the anodic half-reaction GDEa is obtained by means of a technique known to those skilled in the art, examples of which have already been given in the preceding paragraphs.

It is also apparent that it is a further object of the present invention to use a gas diffusion electrode GDE, obtained according to the method described in the present description, to make a fuel cell FC1, FC2, FC3.

Moreover, the present invention also relates to a catalytic composition in particle form for making a gas diffusion electrode GDE for the oxygen reduction reaction. Such a catalytic composition comprises iron (Fe) in at least two different oxidation states and carbon (C), said catalytic composition being preferably obtained at least from the tribo-oxidative action caused by the friction of a brake pad against a brake disc, preferably made of cast iron.

It is apparent that it is a further object of the present invention to use a catalytic composition described in the present description for making a gas diffusion electrode.

Similarly, it is a further object of the present invention to use a gas diffusion electrode according to the description for making a membrane-electrode assembly (MEA) for a fuel cell (FC1, FC2, FC3).

Moreover, it is a further object of the present invention to use a membrane-electrode assembly (MEA) described in the present description for making a fuel cell (FC1, FC2, FC3).

According to an embodiment, in the catalytic composition, iron (Fe) in at least two different oxidation states consists of at least metallic iron (Fe) (i.e., with oxidation state zero, Fe (0)) and hematite (Fe₂O₃) (i.e., with oxidation state three Fe(III)).

According to an embodiment, in the catalytic composition, iron (Fe) in at least two different oxidation states consists of at least metallic iron (α-Fe) and at least magnetite (Fe₃O₄), (i.e., with oxidation state two and three Fe(II, III)).

According to an embodiment, in the catalytic composition, iron (Fe) in at least two different oxidation states consists of at least metallic iron (α-Fe), at least hematite (Fe₂O₃) (i.e., with oxidation state three Fe(III)) and at least magnetite (Fe₃O₄), (i.e., with oxidation states two and three Fe(II, III)).

Moreover, it is apparent that the catalytic composition can be made with any combination of percentage contents of the compounds already described in the embodiments of the preceding paragraphs with reference to the catalytic composition in particle form described in the steps of the method of making a gas diffusion electrode.

According to an aspect, an advantageous general embodiment of the catalytic composition comprises at least iron in at least two different degrees of oxidation (e.g., Fe and Fe₂O₃), carbon (C) in graphite form, and metallic zinc. The presence of at least the above four components results in excellent electrocatalytic performance, even more so when combined with a particle size of a powder mixture as will be detailed later in the present discussion.

According to an embodiment, the catalytic composition consists of a mixture of powders having an average particle size between 0.01 micrometers and 15 micrometers, preferably between 0.03 micrometers and 10 micrometers, extremes included. Preferably, the powders consist of round-shaped particles with rounded edges.

According to an advantageous embodiment, the powders of the catalytic composition exhibit a bimodal dispersion, expressed as a volume percentage, of the particle size, i.e. the size of the radius or maximum chord of each particle forming the powder. Preferably, the bimodal dispersion (or distribution) of powders comprises a first peak between 0.2 and 0.4 micrometers, preferably at 0.3 micrometers, and a second peak between 1 and 4 micrometers, preferably at 3 micrometers. An example of such a bimodal dispersion is shown in FIG. 4.

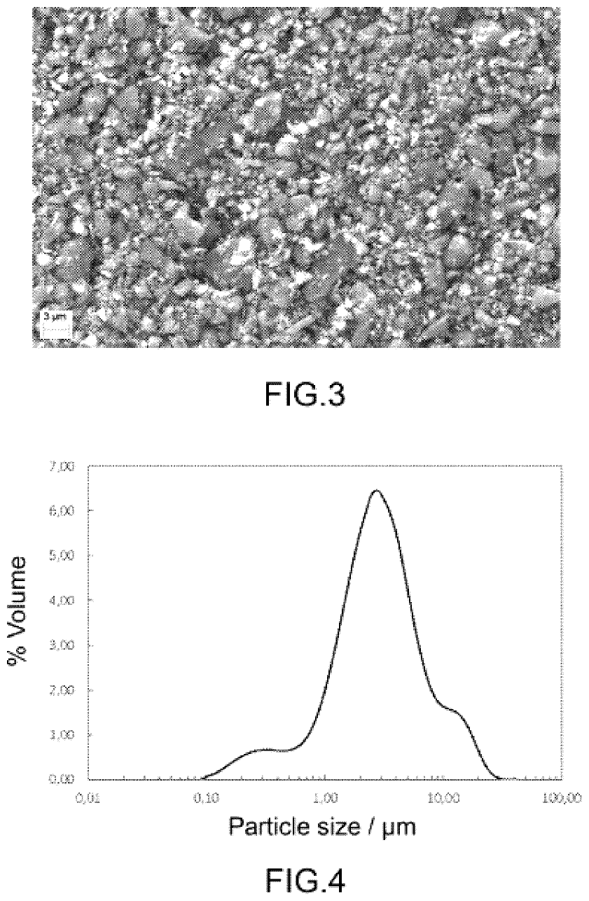

In an advantageous manner, the presence of a population of micrometer particles with bimodal distribution (i.e. large particles surrounded by small particles) ensures an optimal packing of the particles themselves along with minimization of free volume (i.e. volume not occupied by the catalyst particles), such as shown in FIG. 3, for example. This condition facilitates the subsequent obtaining of homogeneous catalyst layers with high load (understood as milligrams of catalytic composition per square centimeter) when making the gas diffusion electrode (GDE).

The invention, with reference to both methods and catalytic composition, will be better described below by means of some explanatory and non-limiting examples.

### Example 1

By way of example, there are shown the results obtained using as a catalyst the powders emitted as a result of a set of braking applications according to the WLTP-Brake cycle (Worldwide-Harmonized Light vehicles Test Procedure for Brakes), reported in M. Mathissen et al., A novel Real-World Braking Cycle for Studying Brake Wear Emissions, Wear, 2018, 414-415, 219-226. Specifically, the disc brake configuration used comprises a friction material of the ECE R90 Low Steel type and a brake disc made of lamellar cast iron with a fully pearlitic metallographic structure. The powders emitted during the WLTP braking test were used to obtain a gas diffusion electrode (GDE) according to the method described in the present invention. The gas diffusion electrode GDE was then tested by means of rotating disc electrode (hereafter RDE) voltammetry measurements with the aim of evaluating the capability to catalyze the oxygen reduction reaction in an alkaline environment (O₂+2H₂O+4e⁻→4OH⁻, E⁰=1.230 V vs. RHE).

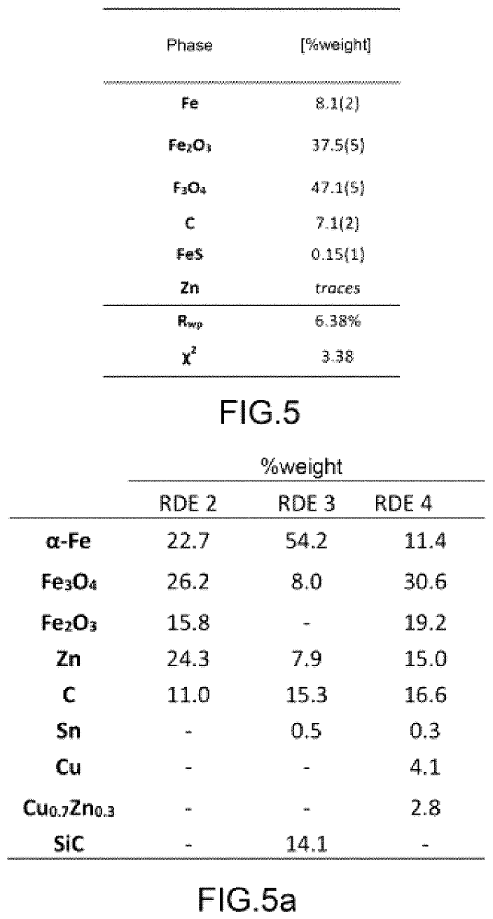

The phase composition of the catalytic composition of this example is shown in FIG. 5. The percentage values of the different phases were calculated by means of x-ray diffraction measurements and subsequent Rietveld analysis.

In this example, the catalytic composition consists of 8.1% metallic iron (Fe), 37.5% hematite (Fe_{>2}O_{>3}), 47.1% magnetite (Fe_{>3}O₄), 7.1% carbon (C), 0.15% iron sulfide (FeS), and small traces of zinc (Zn) (with R_{wp}=6.38% and χ²=3.38 as balance factors obtained at the end of the analysis via Rietveld method).

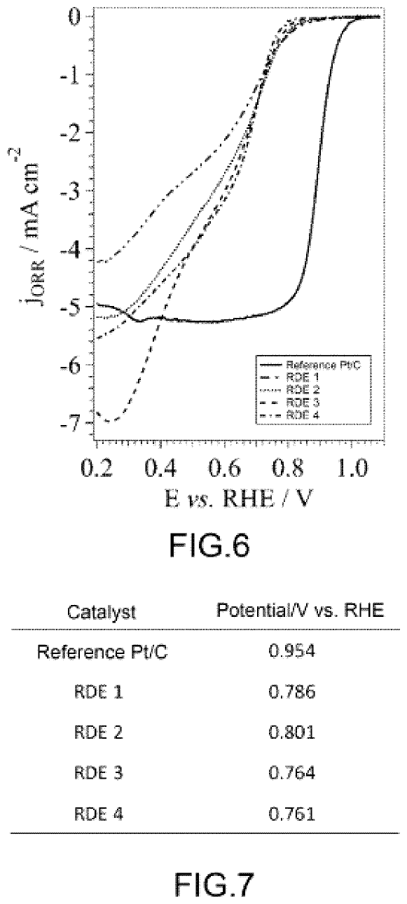

The catalytic activity of the catalytic composition of this example, with reference to the oxygen reduction reaction, was investigated by means of rotating disc electrode (hereafter RDE) voltammetry measurements. This was done by constructing a first rotating electrode (hereafter RDE1) comprising an appropriate catalytic layer comprising the previously described catalytic composition. The RDE was then: a) immersed in an appropriate electrolyte at 25±0.1° C.; b) rotated at 1600 rpm; c) cycled at 20 mV/s in a saturated oxygen solution. Once the voltammogram was stable, a scan towards increasing potentials was performed, as shown in FIG. 6. The data obtained were corrected for ohmic potential drop, as in Van der Vliet et al., J. Electroanal. Chem. 647 (2010) 29-34. Faraday currents associated with the oxygen reduction reaction were obtained by subtracting the voltammogram of the same RDE after cycling in saturated argon electrolyte, according to Jia X. Wang et al, Faraday Discuss. 140 (2008) 347-362.

In particular, in this example, the catalytic layer of RDE1 was obtained by depositing an appropriate catalytic mixture 10 comprising the catalytic composition on a glassy carbon disc electrode. The catalytic mixture 10, in the form of ink, consists of the following composition: 10 mg powder emitted by braking (catalytic composition), 10 mg mesoporous carbon (average particle size of graphite: 45±5 μm; average pore size: 100 Å±10 Å); 12 μL of 5% Nafion™ hydroalcoholic solution, 1 mL of water. The catalytic mixture 10 was sonicated using ultrasound for about 1 h to homogeneously disperse the ink components. A drop (15 μL) of the resulting catalytic mixture 10 was deposited on a glassy graphite electrode and allowed to air dry, thus obtaining RDE1.

The RDE1 was tested in a basic environment using 0.1M KOH solution as the electrolyte, and specifically the cyclic voltammetry was performed in the potential range −0.805/+0.195 V vs. Hg|HgO. The catalyst load is 764 μg of powder per cm².

The performance of the oxygen reduction reaction (ORR) was evaluated by comparing the electrode potential at the current of 100 μA. For reference, the ORR performance of a commercial platinum catalyst consisting of platinum nanoparticles supported on mesoporous carbon was measured. In this case, the catalytic mixture 10 comprising the reference catalyst has the following composition: 1 mg commercial EC20 catalyst (20% Pt on carbon), 12 μL of 5% Nafion™ hydroalcoholic solution, 1 mL of water. A drop (15 μL) of the resulting mixture was deposited on the glassy graphite electrode and allowed to air dry, thus obtaining the RDE layer. The final platinum load of the reference RDE layer is 15 μg Pt per cm².

The comparison of the performance of the catalytic composition included in RDE1 with the reference RDE is shown in FIG. 7.

### Example 2

As an example, the results obtained using as a catalyst the powders emitted as a result of a set of braking applications according to the WLTP-Brake cycle (Worldwide-Harmonized Light vehicles Test Procedure for Brakes) are shown. Specifically, the disc brake configuration used comprises a friction material of the ECE R90 copper-free type and a brake disc made of lamellar cast iron with a fully pearlitic metallographic structure. The powders emitted during the WLTP braking test were used to obtain a gas diffusion electrode (GDE) according to the method described in the present invention. The gas diffusion electrode was then tested by means of rotating disc electrode (hereafter RDE) voltammetry measurements with the aim of evaluating the capability to catalyze the oxygen reduction reaction in an alkaline environment (O₂+2H₂O+4e⁻→4OH⁻, E⁰=1.230 V vs. RHE).

The phase composition of the catalytic composition of this example is shown in FIG. 5a. The percentage values of the different phases were calculated by means of X-ray diffraction measurements and subsequent Rietveld analysis.

In this example, the catalytic composition consists of 22.7% metallic iron (Fe), 15.8% hematite (Fe_{>2}O_{>3}), 26.2% magnetite (Fe_{>3}O₄), 11% carbon (C), 24.3% metallic zinc (Zn).

The catalytic activity of the catalytic composition of this example, with reference to the oxygen reduction reaction, was investigated by means of rotating disc electrode (hereafter RDE) voltammetry measurements, using the same procedure as already described for example 1 (RDE1), by constructing a second rotating electrode (hereafter RDE2) comprising an appropriate catalytic layer comprising the previously described catalytic composition.

The comparison of the performance of the catalytic composition included in RDE2 with the reference RDE is shown in FIG. 7.

### Example 3

As an example, the results obtained using as a catalyst the powders emitted as a result of a set of braking applications according to the WLTP-Brake cycle (Worldwide-Harmonized Light Vehicles Test Procedure for Brakes) are shown. Specifically, the disc brake configuration used comprises a high-performance friction material with a silicone resin binder and a brake disc made of lamellar cast iron with a fully pearlitic metallographic structure. The powders emitted during the WLTP braking test were used to obtain a gas diffusion electrode (GDE) according to the method described in the present invention. The gas diffusion electrode was then tested by means of rotating disc electrode (hereafter RDE) voltammetry measurements with the aim of evaluating the capability to catalyze the oxygen reduction reaction in an alkaline environment (O₂+2H₂O+4e⁻→4OH⁻, E⁰=1.230 V vs. RHE).

The phase composition of the catalytic composition of this example is shown in FIG. 5a. The percentage values of the different phases were calculated by means of X-ray diffraction measurements and subsequent Rietveld analysis.

In this example, the catalytic composition consists of 54.2% metallic iron (Fe), 8.0% magnetite (Fe_{>3}O_{>4}), 15.3% carbon (C), 7.9% zinc (Zn), 14.1% silicon carbide (Sic), and 0.5% tin (Sn).

The catalytic activity of the catalytic composition of this example, with reference to the oxygen reduction reaction, was investigated by means of rotating disc electrode (hereafter RDE) voltammetry measurements, using the same procedure as already described for example 1 (RDE1), by constructing a third rotating electrode (hereafter RDE3) comprising an appropriate catalytic layer comprising the previously described catalytic composition.

The comparison of the performance of the catalytic composition included in RDE3 with the reference RDE is shown in FIG. 7.

### Example 4

As an example, the results obtained using as a catalyst the powders emitted as a result of a set of braking applications according to the WLTP-Brake cycle (Worldwide-Harmonized Light Vehicles Test Procedure for Brakes) are shown. Specifically, the disc brake configuration used comprises a friction material of the ECE R90 copper-full type and a brake disc made of lamellar cast iron with a fully pearlitic metallographic structure. The powders emitted during the WLTP braking test were used to obtain a gas diffusion electrode (GDE) according to the method described in the present invention. The gas diffusion electrode was then tested by means of rotating disc electrode (hereafter RDE) voltammetry measurements with the aim of evaluating the capability to catalyze the oxygen reduction reaction in an alkaline environment (O₂+2H₂O+4e⁻→4OH⁻, E⁰=1.230 V vs. RHE).

The phase composition of the catalytic composition of this example is shown in FIG. 5a. The percentage values of the different phases were calculated by means of X-ray diffraction measurements and subsequent Rietveld analysis.

In this example, the catalytic composition consists of 11.4% metallic iron (Fe), 30.6% magnetite (Fe₃O₄), 19.2% hematite (Fe₂O₃), 16.6% carbon (C), 15% zinc (Zn), 4.1% copper (Cu), 2.8% of copper-zinc alloy, i.e., brass (Cu_{0.7}Zn_{0.3}), and 0.3% of metallic tin (Sn).

The catalytic activity of the catalytic composition of this example, with reference to the oxygen reduction reaction, was investigated by means of rotating disc electrode (hereafter RDE) voltammetry measurements, using the same procedure as already described for example 1 (RDE1), by constructing a fourth rotating electrode (hereafter RDE4) comprising an appropriate catalytic layer comprising the previously described catalytic composition.

The comparison of the performance of the catalytic composition included in RDE4 with the reference RDE is shown in FIG. 7.

As can be appreciated from the foregoing description, the method of making a gas diffusion electrode, the method of making a fuel cell membrane-electrode assembly, the catalytic composition, and the gas diffusion electrode each allow overcoming the drawbacks of the prior art.

In particular, in an innovative manner, the catalytic composition is obtained by the tribo-oxidative action resulting from the friction of a brake pad against a brake disc following the braking process of a motor vehicle.

In a particularly advantageous manner, the method of making a gas diffusion electrode or the method of making a membrane-electrode assembly does not include any pyrolysis step, which is required instead in the methods of the prior art, thus being less energy-consuming or more efficient.

In addition, the methods according to the present invention do not require a step of preparing porous structures of functionalized carbon nor impregnating such porous structures with appropriate iron-based precursors.

In addition, the methods according to the present invention do not require to use templates, e.g., graphene nanoplatelets or zeolitic networks, which generally require particularly complicated and time-consuming syntheses.

In addition, the methods according to the present invention do not include any step of producing or growing functionalized nanotubes (typically by chemical vapor deposition), which are generally very expensive and difficult to scale to large volumes.

In an innovative manner, the gas diffusion electrode, the membrane-electrode assembly, and the catalytic composition are highly suitable for being used as fuel cell cathodes because they are based on abundant and thus inexpensive metals, such as iron, zinc, and do not include noble metals such as platinum, iridium, ruthenium, palladium, nor heavy metals such as nickel, chromium, lead, etc.

In other words, the gas diffusion electrode or the membrane-electrode assembly or the catalytic composition are preferably made without platinum and/or without iridium and/or without ruthenium and/or without palladium.

In other words, the gas diffusion electrode or the membrane-electrode assembly or the catalytic composition are preferably made without heavy metals, e.g., without nickel and/or without chromium and/or without lead, resulting in an immediate beneficial effect for the environment.

Therefore, in a highly advantageous manner, from a circular economy point of view, they allow reusing a waste product, i.e., the particulate emitted by braking, and allow producing effective, efficient, cost-effective, and environmentally friendly catalysts.

Moreover, in a particularly advantageous manner, the presence of graphite (C) in the catalytic composition, preferably homogeneously dispersed, ensures an excellent electrical contact between metal particles and oxides, thus allowing the efficient collection of the electrons generated on electrocatalytically active sites.

In addition, the presence of zinc or secondary contents of metals such as copper or tin advantageously allows modulating the properties of electrochemically active sites by virtue of the oxyphilic and/or amphoteric nature of these elements.

In a particularly advantageous manner, it is worth noting that the presence of iron makes the catalytic composition particularly suitable for catalyzing the oxygen reduction reaction (ORR) in a basic environment, making it suitable for being used in anion exchange polymer electrolyte fuel cells (AEMFCs), which therefore are per se a subject of the present invention.

In addition, the catalytic composition and the electrode according to the present invention do not comprise platinum-group metals (PGMs) and do not suffer from the related problems of cost and unavailability associated with the use of noble metals.

1-15. (canceled)

16. A method of making a gas diffusion electrode (GDE) for an oxygen reduction reaction, the method comprising steps of:
a) providing a catalytic composition in particle form comprising at least iron (Fe) in at least two different degrees of oxidation, optionally the at least two different degrees of oxidation being Fe and Fe₂O₃, and carbon (C), the catalytic composition in particle form being obtained from a tribo-oxidation action caused by a friction of a brake pad against a brake disc;
b) combining the catalytic composition in particle form obtained in step a) with a liquid phase to obtain a catalytic mixture; and
c) depositing the catalytic mixture obtained in step b) on a backing sheet and letting the catalytic mixture dry.

17. The method of claim 16, wherein, in step c), the backing sheet is a porous carbon sheet.

18. The method of claim 16, wherein the liquid phase of step b) is constituted by a mixture of a polar solvent comprising an ion-conducting ionomer and mesoporous carbon.

19. The method of claim 16, wherein the catalytic composition in particle form consists of at least 15% of ferrous metal particles, at least 5% of graphite, metal zinc (Zn) in a content of less than 40%, and other constituents for a remaining percentage by weight.

20. The method of claim 19, wherein the content of metal zinc (Zn) is less than 30%.

21. The method of claim 19, wherein said ferrous metal particles comprise at least 5% of metallic iron (α-Fe) and at least 5% of magnetite (Fe₃O₄) by weight.

22. The method of claim 21, wherein said ferrous metal particles comprise at least 5% of metallic iron (α-Fe), at least 5% of magnetite (Fe₃O₄) and at least 5% of hematite (Fe₂O₃) by weight.

23. The method of claim 21, wherein the catalytic composition in particle form consists of 5% to 60% of metallic iron (α-Fe), extremes included, 5% to 55% of magnetite (Fe₃O₄), extremes included, 5% to 40% of hematite (Fe₂O₃), extremes included, 5% to 20% of graphite, extremes included, metallic zinc (Zn) in a content of less than 40%, and other constituents for a remaining percentage by weight.

24. The method of claim 23, wherein the content of metal zinc (Zn) is less than 30%.

25. The method of claim 23, wherein the catalytic composition in particle form consists of 5% to 10% of metallic iron (α-Fe), extremes included, 30% to 40% of hematite (Fe₂O₃), extremes included, 40% to 50% of magnetite (Fe₃O₄), extremes included, 5% to 10% of graphite, extremes included, metallic zinc (Zn) in a content of less than 5%, and other constituents for the remaining percentage by weight.

26. The method of claim 27, wherein the content of metallic zinc (Zn) is less than 1%.

27. The method of claim 16, wherein, before step a), the method comprises a step a′) of collecting a waste powder from the tribo-oxidation action caused by the friction of the brake pad against the brake disc, directly near the brake pad and/or the brake disc, so as to obtain the catalytic composition in particle form.

28. The method of claim 16, wherein, before step a), the method comprises a step a″) of treating a waste powder from the tribo-oxidative action caused by the friction of the brake pad against the brake disc, by at least one of a filtration process, a grinding process, a washing process, so as to obtain the catalytic composition in particle form.

29. The method of claim 16, wherein said method does not involve any pyrolysis step of the catalytic composition in particle form.

30. A method of making a membrane-electrode assembly (MEA) for a fuel cell, the method comprising operational steps of a method of making a gas diffusion electrode (GDE) for an oxygen reduction reaction comprising steps of:
a) providing a catalytic composition in particle form comprising at least iron (Fe) in at least two different degrees of oxidation, optionally the at least two different degrees of oxidation being Fe and Fe₂O₃, and carbon (C), the catalytic composition in particle form being obtained from a tribo-oxidation action caused by a friction of a brake pad against a brake disc;
b) combining the catalytic composition in particle form obtained in step a) with a liquid phase to obtain a catalytic mixture; and
c) depositing the catalytic mixture obtained in step b) on a backing sheet and letting the catalytic mixture dry, and the following steps:
joining a first side of a polymer membrane to the backing sheet of the GDE for the oxygen reduction reaction, so as to obtain a cathode side of the MEA; and
joining a second side of the polymer membrane, opposite to the first side, to the GDE for an anodic half-reaction (GDEa).

31. A method of making a membrane-electrode assembly (MEA) for a fuel cell, the method comprising operational steps of a method of making a gas diffusion electrode (GDE) for an oxygen reduction reaction comprising steps of:
a) providing a catalytic composition in particle form comprising at least iron (Fe) in at least two different degrees of oxidation, optionally the at least two different degrees of oxidation being Fe and Fe₂O₃, and carbon (C), the catalytic composition in particle form being obtained from a tribo-oxidation action caused by a friction of a brake pad against a brake disc;
b) combining the catalytic composition in particle form obtained in step a) with a liquid phase to obtain a catalytic mixture; and
c) depositing the catalytic mixture obtained in step b) on a backing sheet and letting the catalytic mixture dry, and the following steps:
joining a first side of the backing sheet of the GDE for the oxygen reduction reaction to a porous carbon sheet, so as to obtain a cathode side of the MEA, wherein the backing sheet of the GDE is a polymer membrane, and
joining an opposite side to the first side of the backing sheet to the GDE for an anodic half-reaction (GDEa).

32. A method for making a fuel cell, said method comprising using the GDE obtained by the method of claim 16.

33. A catalytic composition in particle form for making a gas diffusion electrode (GDE) for an oxygen reduction reaction, the catalytic composition in particle form comprising at least iron (Fe) in at least two different degrees of oxidation, optionally the at least two different degrees of oxidation being Fe and Fe₂O₃, and carbon (C), the catalytic composition in particle form being obtained at least from a tribo-oxidation action caused by a friction of a brake pad against a brake disc.
